(19) United States
(12) Patent Application Publication
(10) Pub. No.: US 2026/0127535 A1
(43) Pub. Date: May 7, 2026

(54) SYSTEMS AND METHODS FOR ACCELERATING PROCESS TRANSFORMATION OPPORTUNITY IDENTIFICATION USING GENERATIVE AI

(71) Applicant: Hitachi, Ltd., Tokyo (JP)

(72) Inventors: Dipanjan GHOSH, Santa Clara, CA (US); Ahmed FARAHAT, Santa Clara, CA (US); Chetan GUPTA, Santa Clara, CA (US)

(21) Appl. No.: 18/935,310

(22) Filed: Nov. 1, 2024

(51) Int. Cl. G06Q 10/0639

(52) U.S. Cl. CPC G06Q 10/06393

(57) ABSTRACT

Systems and methods for accelerating the identification of process transformation opportunities offer a data-driven, systematic approaches that incorporate generative AI and user input. Organizational processes are modeled to extract customer pain points, create process activity graphs, identify, and compute key performance indicators (KPIs), benchmark against similar organizations, and simulate business value to highlight transformation opportunities. Embodiments leverage existing knowledge base of customer profiles and solutions to enhance the accuracy of process improvement recommendations.

### BACKGROUND

### Field

The present disclosure is generally directed to information handling systems, and more specifically, to systems and methods for identifying and improving processes in businesses and other entities.

### Related Art

Organizations are composed of various processes, which consist of a network of associated entities and activities. To improve an organization, these processes need to be created or transformed. Traditionally, consultants and domain experts identify opportunities within a process using their experience. However, their perspective can be biased and may overlook other valuable opportunities for transformation. Relying solely on consultants and domain experts alone is non-scalable and introduces the potential of subjective decision-making. Business process mining has been an active area of work and several tools exist. However, these tools seldom consider process information in an unstructured format, as they mostly work on transactional data.

To address various technical problems, embodiments herein provide data-driven systems and methods that combine generative artificial intelligence (AI)-based process understanding and human-in-loop approaches to systematically perform some or all of the following steps, which may leverage a knowledge bank of solutions developed based on existing customers: (1) providing systems and methods for modeling organizational process using generative AI and standardized customer profiles comprising extracted attributes; (2) extracting customer pain points; (3) implementing methods for understanding processes and extract processes as graph data structures, where entities and activities are associated with each other; (4) developing methods for process-activity key performance indicator (KPI) identification, computation, and opportunity identification using on-field generated data; and (5) establishing methods for identifying opportunities within the process for transformation by benchmarking against similar organizations and process activities' KPIs, simulating transformation business value, and identifying opportunities worth transforming.

### SUMMARY

In some aspects of the disclosure, an optimization method for identifying and recommending process transformation opportunities for an organization comprises: providing unstructured data associated with customer information, which is obtained from unstructured data sources including at least one of user-entered data, a customer portal, or an external source, as an input to a generative AI to obtain customer attributes; creating a customer profile and storing it, along with embeddings of the customer attributes, in a customer knowledge base (KB), wherein the generative AI uses a large language model (LLM) to obtain from the unstructured data a customer pain point that is stored as raw data in the customer process KB and as embedded pain point in a customer process vector database (DB); using the embedded pain point and the customer attribute to perform a lookup or a similarity search in the customer process vector DB to identify and obtain a related process activity graph associated with existing customer data and at least one of a related standardized customer pain point or a related process; identifying an activity associated with a node or an edge of the related process activity graph that increases a likelihood of maximizing a value; for at least some of the nodes and/or edges, iteratively performing steps including: in response to identifying a KPI associated with the activity, computing the KPI by using at least one of the similarity search or a domain expertise and at least one of a formula or KPI information, which is obtained by using a similarity search on the customer KB, to identify a potential improvement in the KPI based on a comparative analysis of the computed KPIs with similar KPIs associated with similar organizations; and selecting and outputting at least one of the customer pain point, process, or a process activity, which based on the computed KPI that has the highest likelihood of maximizing the value.

In some aspects, the optimization method further comprises, in response to no related standardized customer pain point or related process associated with existing customer data being identified, accepting as related process a user-entered process or domain expert-provided process, and storing the related process as embedded related process in the customer process vector DB.

In some aspects, the optimization method further comprises, in response to the KPI being identified based on the domain expertise, storing the KPI as new information in the KB.

In some aspects, the similar KPIs are obtained by benchmarking against at least one of organizational data, an industry standard, or publicly available information.

In some aspects, the optimization method further comprises, in response to no related process activity graph being identified, providing the unstructured data to the generative AI to generate a process activity graph in lieu of the related process activity graph.

In some aspects, the potential improvement is derived from a domain expertise, a business simulation, or automatically by using the formula, which along with the KPI information may be derived from the domain expertise and stored in a database.

In some aspects, the potential improvement serves as an input to a value computation that, for each potential KPI improvement, computes the value.

In some aspects, the optimization method further comprises causing the generative AI to use the related process to recommend or generate, based on the customer attributes and the customer pain point, the process activity graph.

In some aspects, the optimization method further comprises, in response to the value being computed, using the formula to identify at least one of a pain point or a process activity.

In some aspects, the optimization method further comprises verifying the process activity graph by domain experts to ensure accuracy and saving the verified process activity graph in the process activity vector DB.

In some aspects, the unstructured data sources include at least one of a customer discussion, meeting notes, or a recorded meeting.

In some aspects, the customer attributes include a name, an industry, an organization type, and a revenue amount.

In some aspects, the node represents an entity including a machine or a material.

In some aspects, the optimization method further comprises saving a newly identified KPI or process activity in a future use of the customer process vector DB.

In some aspects, the optimization method further comprises updating the customer KB with pre- and post-transformation KPIs for future comparative analysis.

In some aspects, the optimization method further comprises encoding and storing, for the related process, a process name in at least one of the customer process vector DB or the customer process KB.

Some aspects of the disclosure comprise a non-transitory computer-readable medium for storing instructions for executing a process, the instructions including: providing unstructured data associated with customer information, which is obtained from unstructured data sources including at least one of user-entered data, a customer portal, or an external source, as an input to a generative AI to obtain customer attributes; creating a customer profile and storing it, along with embeddings of the customer attributes, in a customer KB, wherein the generative AI uses an LLM to obtain from the unstructured data a customer pain point that is stored as raw data in the customer process KB and as embedded pain point in a customer process vector DB; using the embedded pain point and the customer attribute to perform a lookup or a similarity search in the customer process vector DB to identify and obtain a related process activity graph associated with existing customer data and at least one of a related standardized customer pain point or a related process; identifying an activity associated with a node or an edge of the related process activity graph that increases a likelihood of maximizing a value; for at least some of the nodes and/or edges, iteratively performing steps including: in response to identifying a KPI associated with the activity, computing the KPI by using at least one of the similarity search or a domain expertise and at least one of a formula or KPI information, which is obtained by using a similarity search on the customer KB, to identify a potential improvement in the KPI based on a comparative analysis of the computed KPIs with similar KPIs associated with similar organizations; and selecting and outputting at least one of the customer pain point, process, or a process activity, which based on the computed KPI that has the highest likelihood of maximizing the value.

Aspects of the present disclosure can involve a system, which can involve means for performing steps comprising: providing unstructured data associated with customer information, which is obtained from unstructured data sources including at least one of user-entered data, a customer portal, or an external source, as an input to a generative AI to obtain customer attributes; means for creating a customer profile and storing it, along with embeddings of the customer attributes, in a customer KB, wherein the generative AI uses an LLM to obtain from the unstructured data a customer pain point that is stored as raw data in the customer process KB and as embedded pain point in a customer process vector DB; means for using the embedded pain point and the customer attribute to perform a lookup or a similarity search in the customer process vector DB to identify and obtain a related process activity graph associated with existing customer data and at least one of a related standardized customer pain point or a related process; means for identifying an activity associated with a node or an edge of the related process activity graph that increases a likelihood of maximizing a value; means for iteratively performing steps including, for at least some of the nodes and/or edges, the steps including: in response to identifying a KPI associated with the activity, computing the KPI by using at least one of the similarity search or a domain expertise and at least one of a formula or KPI information, which is obtained by using a similarity search on the customer KB, to identify a potential improvement in the KPI based on a comparative analysis of the computed KPIs with similar KPIs associated with similar organizations; and means for selecting and outputting at least one of the customer pain point, process, or a process activity, which based on the computed KPI that has the highest likelihood of maximizing the value.

### BRIEF DESCRIPTION OF DRAWINGS

FIG. 1 illustrates exemplary components and steps for an optimization system for identifying and recommending process transformation opportunities, according to various embodiments of the present disclosure.

FIG. 2A-FIG. 2F illustrate an exemplary process flow for an end-to-end process transformation accelerator AI system according to various embodiments of the present disclosure.

FIG. 3 is a flowchart illustrating an exemplary optimization process for identifying and recommending process transformation opportunities for, in accordance with various embodiments of the present disclosure.

FIG. 4 illustrates an example computing environment with an example computer device, according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In this document, the terms “pain point” and “customer pain point” are used interchangeably. Customer pain point refers to any actual or perceived operational deficiencies or issues associated with entities and activities of an organization, which are subject to identification and improvement. Further, the terms “opportunity” and “transformation opportunity” are used interchangeably. As discussed in greater detail below, a transformation opportunity may be expressed as or derived from a combination of a pain point, a process, an activity, and a value or similar metrics for measuring how effectively an organization is reaching predefined business targets to identify areas for improvement.

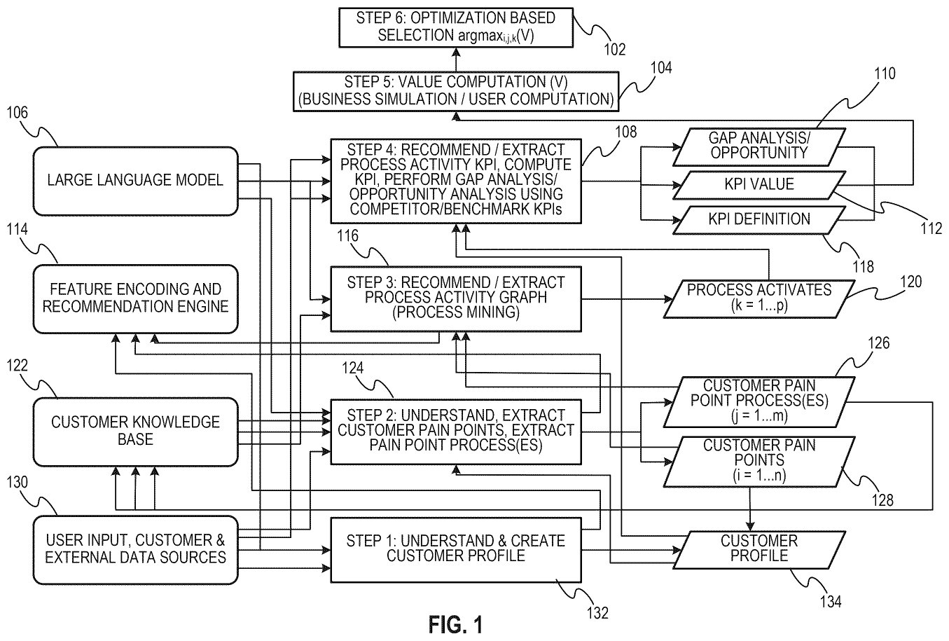

FIG. 1 illustrates exemplary components and steps for an optimization system for identifying and recommending process transformation opportunities, according to various embodiments of the present disclosure.

In embodiments, step 1 in FIG. 1 comprises providing user-entered unstructured data, which may have been obtained from customer portals and/or external sources, and relationships extracted therefrom as input to a generative AI model that extracts pre-defined customer attributes or parameters, such as name, organization type, industry, revenue, etc. In preparation for modeling an organizational process, the attributes may be encoded and stored in a customer profile within the organization's customer KB.

In embodiments, step 2 comprises using a generative AI model to identify one or more customer pain points, e.g., by using the unstructured data, e.g., customer discussions, meeting notes, etc., as inputs to the generative AI model. In embodiments, the identified customer pain points obtained from the unstructured data may be standardized. For example, the customer KB may exist in a standardized format that matches that of the unstructured data. In scenarios where a customer pain point identified from the unstructured data does not yet exist in the customer KB, it may be created and stored therein. In addition, a related pain point process may be identified, e.g., by using a customer process KB, which may comprise a set of related pain points, pain point processes, prior solutions etc., that can be associated with customer profile. Similar to customer pain point, if a related customer pain point process does not yet exist in the customer process KB, a domain expert or user may enter a related process. The process name may be encoded and saved in the customer process KB.

In embodiments, step 3 comprises obtaining from the customer process KB a related process activity graph that may represent entities and activities, e.g., documentation-related process steps, associated with an organization. As discussed in greater detail further below, each process step may be associated with a KPI (e.g., a customer satisfaction score related to wait times, repair returns, etc.), which can be quantified and used in an optimization or recommendation algorithm that processes data sets that define a combination of pain point, process, activity, and value as an opportunity that can be recommended. It is noted that process activity graphs are not intended as a limitation on the present disclosure since other data structures may equally be used to describe various processes. In embodiments, if an activity graph cannot be obtained, a suitable related process activity graph may be obtained from a generative AI that is provided the unstructured data and the customer profile to identify and analyze relationships in the unstructured data to recommend suitable related process activity graphs. It is understood that generative AI may be prompted to generate a process activity graph directly from any number of, e.g., audio or video data sources.

In embodiments, step 4 comprises using AI to recommend, based on the customer profile, a number of process activity KPIs that each may be associated with a particular process in the process activity graph obtained at step 3. Each process, in turn, may be associated with any number of activities that each may correspond to a different KPI. If a KPI cannot be obtained or recommended, user feedback may be solicited. To compute a KPI, embodiments connect to the customer process KB, e.g., to obtain, for similar customer profiles, processes, process-activities, pre- and post-solution implementation KPIs for each customer pain point. The KPIs may then be used to perform comparative gap analysis or proceed to value computation. If pre- and post-solution implementation KPI are not available, then proceed to value computation.

In embodiments, at step 5, given a pain point, a process, and an activity, a business simulation may be performed that may further use inputs from domain experts to compute a business value. Such a business simulation may use at least one of a KPI value, a KPI definition, or a gap analysis to identify an opportunity.

In embodiments, step 6 involves selecting the pain point, associated process, and/or process activity having a maximum value that represents the opportunity for transformation.

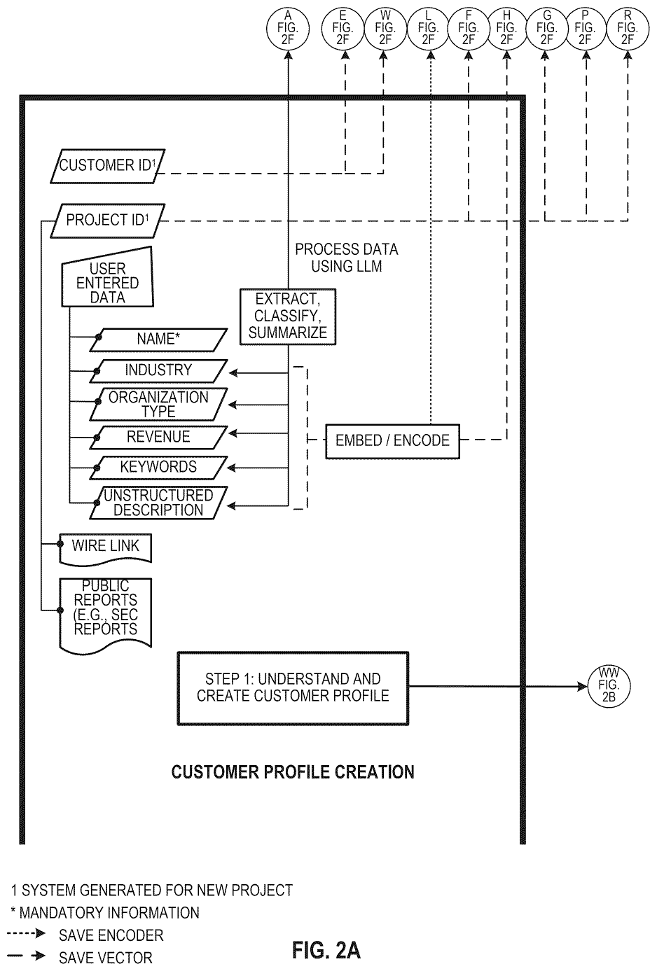

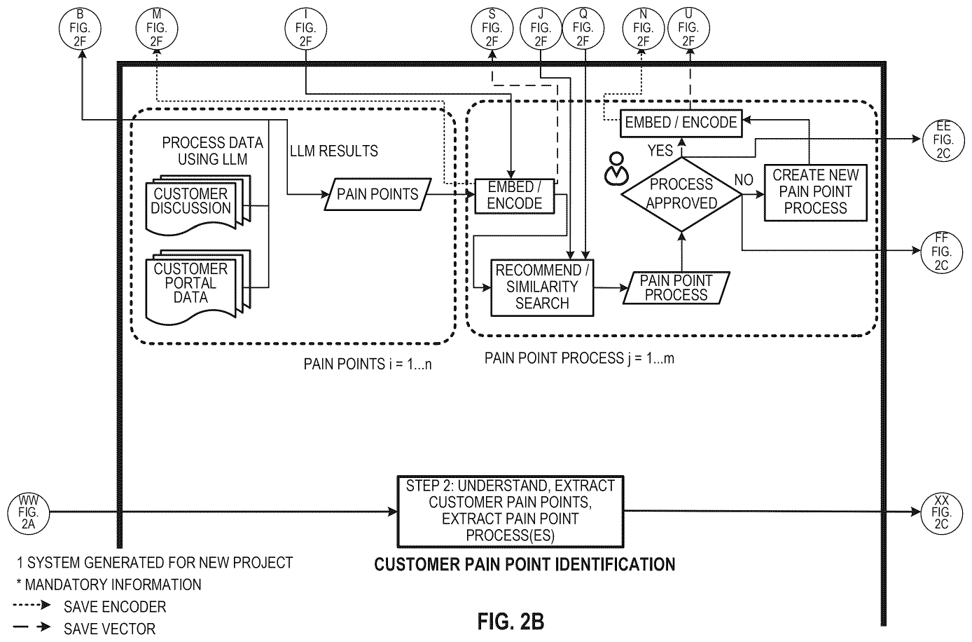

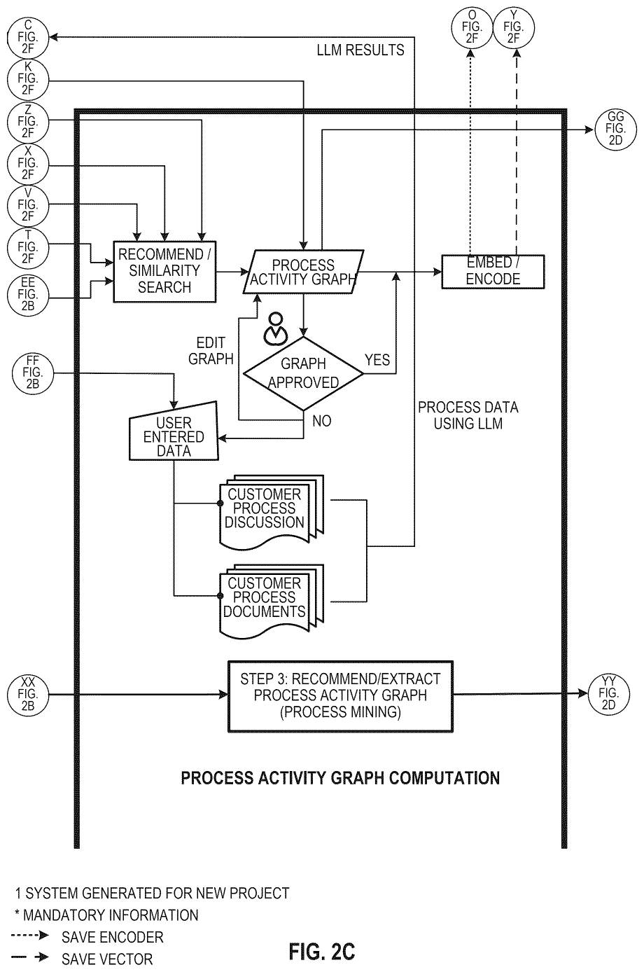

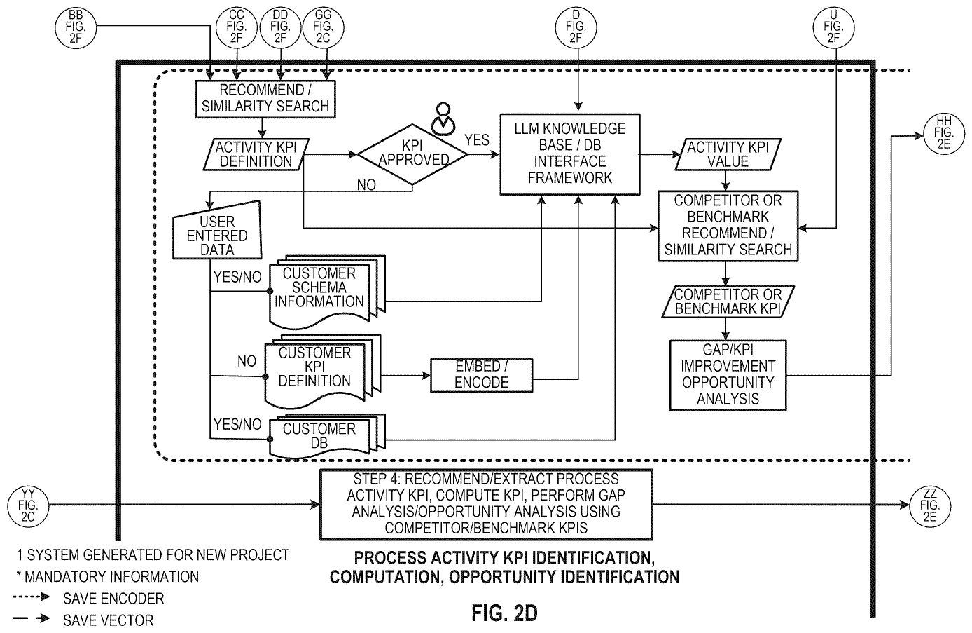

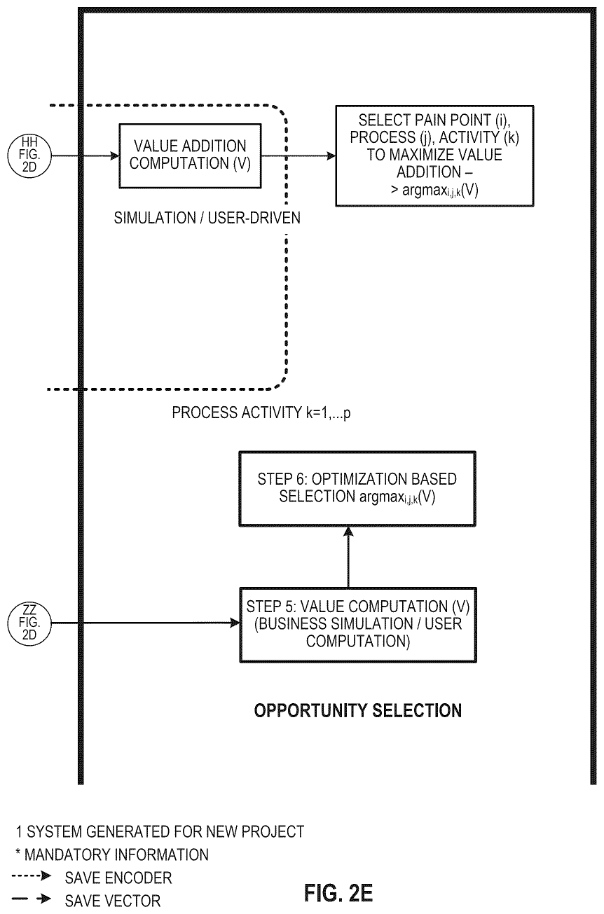

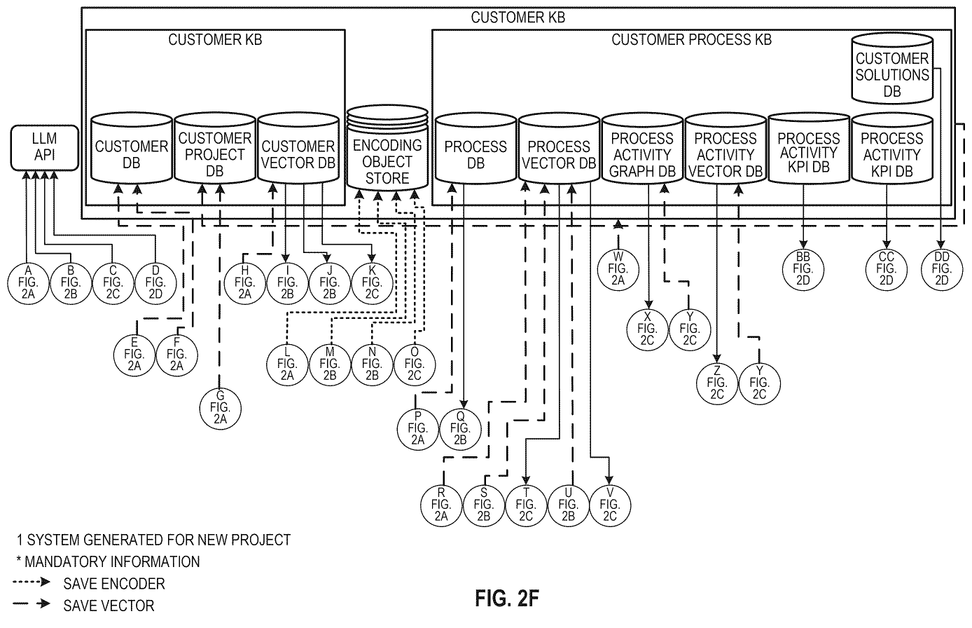

FIG. 2A-FIG. 2F, which illustrate an exemplary process flow for an end-to-end process transformation accelerator AI system according to various embodiments of the present disclosure, provides additional details of individual components or steps depicted in FIG. 1. As depicted process flow 200 may comprise customer KB, customer process KB, encoding object store, and LLM API, which may be implemented as a generative AI LLM API service, such as OpenAI service, Mistral AI API service, Llama2 API service, or similar.

In embodiments, customer KB may comprise a collection of customer-related information and customer project information that is stored in a DB. That customer information may further be embedded or encoded and saved in embedded form in a vector DB, which may be viewed as part of the customer KB.

In embodiments, a process KB may comprise process-related information. Process KB may comprise the following databases: a process DB, a process activity graph DB, a process activity KPI DB, and a customer solutions DB. As for the customer KB, information in any of these databases may also be embedded and stored in a respective vector DB, i.e., a process vector DB, a process activity vector DB, and a process activity KPI vector DB.

In embodiments, an encoding object store may store encoding or embedding models used throughout process flow 200.

In embodiments, in a customer profile creation step, the customer information may be profiled by using customer profile attributes, such as name, industry, organization type, revenue, etc. The attributes may be extracted from unstructured data or user-entered data. Unstructured data may be obtained from customer discussions, customer online portals, meeting notes, etc. The customer profile attributes, along with their embeddings, are then saved in the customer KB.

In embodiments, in a customer pain point identification step, customer pain points (PPi) are extracted from the unstructured data that is communicated to the LLM API, which generates a list of PPi. The raw information, e.g., text, audio, video and other unstructured data, and raw extracted pain points are saved in the customer process KB (hereinafter also refer to as “process KB”). The extracted pain points are embedded, and a lookup or similarity search is performed in the process vector DB to identify the closest standardized pain points (if any). The search may be performed using the customer attributes and embedded pain point; otherwise, the embedded pain point is saved in the customer vector DB.

In embodiments, the embedded pain points may be used to perform a look-up or similarity search in the process vector DB to obtain a closest associated process (PRj), if any. This search may be performed using the customer attributes and embedded customer pain points to extract the closest associated process for a similar customer, the knowledge of which has been captured in the customer process KB. If no existing process is found, the process may be treated as new knowledge and saved in the customer process KB.

In embodiments, process activity graph computations involve a process that is modeled by using a directed graph data structure, which comprises nodes associated with entities, such as man, machine, material, while graph edges represent activities being performed or information being transferred. In this way, a process can be standardized as a process activity graph. In embodiments, using the embedded process from the process KB and the customer attributes, a similarity search may be performed to extract the relevant process activity graph, if any. If no relevant process activity graph is found, then unstructured information regarding a process may be used to generate an activity graph by providing unstructured information, which may comprise process documents, meeting notes, recorded meetings, videos, etc., to an LLM to extract a process activity graph. The graph may then be verified, e.g., by domain experts. The raw information may be saved in the process activity graph DB, while embedded information is saved in the process activity vector DB. Verification is also performed for the process activity graph extracted from the customer process KB. The process graph activities associated with a process (entities or nodes) represented as PRAₖ. An overall goal may comprise identifying transformation opportunities by using the process activity graph as the information, e.g., to find a node or an edge that has the potential for a transformation to maximize a value creation.

In embodiments, steps such as process activity KPI identification, computation, and opportunity identification may comprise a value creation by transforming an activity in the process activity graph driven by a KPI and/or an improvement associated therewith. In embodiments, value computation may be achieved by identifying KPIs associated with nodes and edges of the process activity graph. These KPIs may be identified, e.g., with the help of domain experts or by using a similarity search mechanism on the information available in the process KB. If KPIs are obtained from domain experts, they may be saved as new information in the KB. For the similarity search mechanism, customer attribute embeddings and process activity graph embeddings may be used. A domain expert or the KB may also provide any number of formulae, metrics (e.g., ratios), or definitions for use in computing the KPI.

In embodiments, to compute KPIs, information related to the transaction information database may be obtained from technical experts. Using this information, process flow 200 may connect to a database and compute a KPI using a formula. If this is not feasible, a domain expert may provide a KPI, e.g., a KPI that an expert may have been tracking.

In embodiments, once a KPI is computed, a gap or comparative analysis may be performed. In this way, process activity KPIs may be compared against similar KPIs associated with relevant or similar other organizations. For some calculations, it is assumed that pre- and post-transformation KPIs for the similar organizations are available in the customer KB, i.e., information related to similar organizations may be already stored in the KB. Such information may at least partially be based on industry standards, publicly available information, or any other mechanism. Using a similarity search mechanism on customer KB and process KB, the KPI information may be obtained, and a comparative analysis may be performed to obtain a potential improvement in KPI that may apply to all nodes and edges (if possible) and may serve as an input to a value computation.

In embodiments, an opportunity selection may comprise, generating, for each available KPI improvement, a Value (V). To accomplish this, a computation may be performed manually, e.g., by a domain expert, by a business simulation, or in an automated fashion by using formulae. Once the value has been computed, an associated pain point (PPi), a process (PRj), or a process activity (PRAₖ) may be identified, e.g., by using the formula argmax_{i,,k}(V).

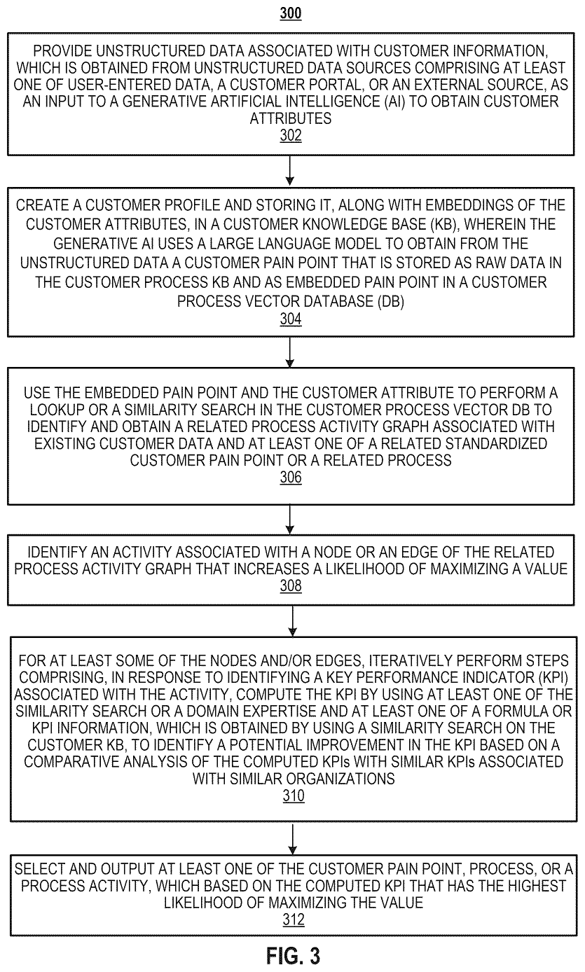

FIG. 3 is a flowchart illustrating an exemplary optimization process for identifying and recommending process transformation opportunities for an organization, in accordance with various embodiments of the present disclosure. In embodiments, process 300 may start at step 302, when a generative AI receives an input comprising unstructured data associated with customer information. This input may be obtained from unstructured data sources comprising at least one of user-entered data, a customer portal, or an external source, as an input to a generative AI to obtain customer attributes.

At step 304, a customer profile is created and stored, along with embeddings of the customer attributes, in a customer KB. In embodiments, the generative AI uses an LLM to obtain from the unstructured data a customer pain point that is stored as raw data in the customer process KB and as embedded pain point in a customer process vector DB.

At step 306, the embedded pain point and the customer attribute may be used to perform a lookup or a similarity search in the customer process vector DB to identify and obtain a related process activity graph associated with existing customer data and at least one of a related standardized customer pain point or a related process.

At step 308, an activity, which is associated with a node or an edge of the related process activity graph that increases a likelihood of maximizing a value, is identified.

At step 310, for at least some of the nodes and/or edges, iteratively, steps may be performed comprising, in response to identifying a KPI associated with the activity, computing the KPI by using at least one of the similarity search or a domain expertise and at least one of a formula or KPI information. The KPI information may be obtained by using a similarity search on the customer KB, to identify a potential improvement in the KPI based on a comparative analysis of the computed KPIs with similar KPIs associated with similar organizations.

Finally, at step 312, at least one of the customer pain point, process, or a process activity may be selected and output. In embodiments, the output may be based on the computed KPI that has the highest likelihood of maximizing the value.

One skilled in the art shall recognize that: (1) certain steps may optionally be performed; (2) steps may not be limited to the specific order set forth herein; (3) certain steps may be performed in different orders; and (4) certain steps may be done concurrently.

It is noted that although the invention is generally described in the context of business processes, it is understood that this is not intended to limit the scope of the present disclosure to such embodiments as the systems and methods for recommending process transformation opportunities described herein may be used in other organizations and entities.

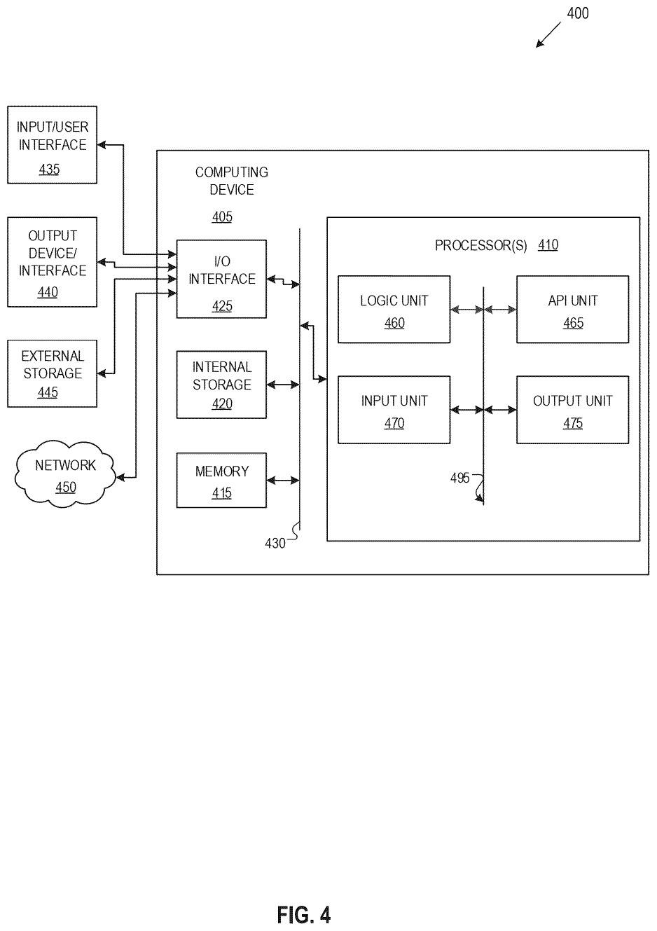

FIG. 4 illustrates an example computing environment with an example computer device suitable for use in some example implementations. Computer device 405 in computing environment 400 can include one or more processing units, cores, or processors 410, memory 415 (e.g., RAM, ROM, and/or the like), internal storage 420 (e.g., magnetic, optical, solid-state storage, and/or organic), and/or I/O interface 425, any of which can be coupled on a communication mechanism or bus 430 for communicating information or embedded in the computer device 405. I/O interface 425 is also configured to receive images from cameras or provide images to projectors or displays, depending on the desired implementation.

Computer device 405 can be communicatively coupled to input/user interface 435 and output device/interface 440. Either one or both of input/user interface 435 and output device/interface 440 can be a wired or wireless interface and can be detachable. Input/user interface 435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 440 may include a display, television, monitor, printer, speaker, braille, or the like. In some example implementations, input/user interface 435 and output device/interface 440 can be embedded with or physically coupled to the computer device 405. In other example implementations, other computer devices may function as or provide the functions of input/user interface 435 and output device/interface 440 for a computer device 405.

Examples of computer device 405 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 405 can be communicatively coupled (e.g., via I/O interface 425) to external storage 445 and network 450 for communicating with any number of networked components, devices, and systems, including one or more computer devices of the same or different configurations. Computer device 405 or any connected computer device can function as, providing services of, or referred to as a server, client, thin server, general machine, special-purpose machine, or another label.

I/O interface 425 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 400. Network 450 can be any network or combination of networks (e.g., the Internet, local area network, wide area network, a telephonic network, a cellular network, a satellite network, and the like).

Computer device 405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 410 can execute under any operating system (OS) (not shown), in a native or virtual environment. One or more applications can be deployed that include logic unit 460, application programming interface (API) unit 465, input unit 470, output unit 475, and inter-unit communication mechanism 495 for the different units to communicate with each other, with the OS, and with other applications (not shown). The described units and elements can be varied in design, function, configuration, or implementation and are not limited to the descriptions provided. Processor(s) 410 can be in the form of hardware processors such as central processing units (CPUs) or a combination of hardware and software units.

In some example implementations, when information or an execution instruction is received by API unit 465, it may be communicated to one or more other units (e.g., logic unit 460, input unit 470, output unit 475). In some instances, logic unit 460 may be configured to control the information flow among the units and direct the services provided by API unit 465, input unit 470, and output unit 475, in some example implementations described above. For example, the flow of one or more processes or implementations may be controlled by logic unit 460 alone or in conjunction with API unit 465. The input unit 470 may be configured to obtain input for the calculations described in the example implementations, and the output unit 475 may be configured to provide output based on the calculations described in example implementations.

Processor(s) 410 can be configured to execute a method or computer instructions which can involve, providing unstructured data associated with customer information, which is obtained from unstructured data sources including at least one of user-entered data, a customer portal, or an external source, as an input to a generative AI to obtain customer attributes; and creating a customer profile and storing it, along with embeddings of the customer attributes, in a customer KB, wherein the generative AI uses a large language model to obtain from the unstructured data a customer pain point that is stored as raw data in the customer process KB and as embedded pain point in a customer process vector DB, as described, for example, with respect to FIG. 2A-FIG. 2F.

Processor(s) 410 can be further configured to execute a method or computer instructions which can involve using the embedded pain point and the customer attribute to perform a lookup or a similarity search in the customer process vector DB to identify and obtain a related process activity graph associated with existing customer data and at least one of a related standardized customer pain point or a related process; identifying an activity associated with a node or an edge of the related process activity graph that increases a likelihood of maximizing a value, as described, for example, with respect to FIG. 2A-FIG. 2F and FIG. 3.

For at least some of the nodes and/or edges, processor(s) 410 can be further configured to execute a method or computer instructions which can involve iteratively performing steps including: in response to identifying a KPI associated with the activity, computing the KPI by using at least one of the similarity search or a domain expertise and at least one of a formula or KPI information, which is obtained by using a similarity search on the customer KB, to identify a potential improvement in the KPI based on a comparative analysis of the computed KPIs with similar KPIs associated with similar organizations; and selecting and outputting at least one of the customer pain point, process, or a process activity, which based on the computed KPI that has the highest likelihood of maximizing the value.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. An optimization method for identifying and recommending process transformation opportunities for an organization, the method comprising:
providing unstructured data associated with customer information, which is obtained from unstructured data sources comprising at least one of user-entered data, a customer portal, or an external source, as an input to a generative artificial intelligence (AI) to obtain customer attributes;
creating a customer profile and storing it, along with embeddings of the customer attributes, in a customer knowledge base (KB), wherein the generative AI uses a large language model to obtain from the unstructured data a customer pain point that is stored as raw data in the customer process KB and as embedded pain point in a customer process vector database (DB);
using the embedded pain point and the customer attribute to perform a lookup or a similarity search in the customer process vector DB to identify and obtain a related process activity graph associated with existing customer data and at least one of a related standardized customer pain point or a related process;
identifying an activity associated with a node or an edge of the related process activity graph that increases a likelihood of maximizing a value;
for at least some of the nodes and/or edges, iteratively performing steps comprising:
in response to identifying a key performance indicator (KPI) associated with the activity, computing the KPI by using at least one of the similarity search or a domain expertise and at least one of a formula or KPI information, which is obtained by using a similarity search on the customer KB, to identify a potential improvement in the KPI based on a comparative analysis of the computed KPIs with similar KPIs associated with similar organizations; and
selecting and outputting at least one of the customer pain point, process, or a process activity, which based on the computed KPI that has the highest likelihood of maximizing the value.

2. The method of claim 1, further comprising, in response to no related standardized customer pain point or related process associated with existing customer data being identified, accepting as related process a user-entered process or domain expert-provided process, and storing the related process as embedded related process in the customer process vector DB.

3. The method of claim 1, further comprising, in response to the KPI being identified based on the domain expertise, storing the KPI as new information in the KB.

4. The method of claim 3, wherein the similar KPIs are obtained by benchmarking against at least one of organizational data, an industry standard, or publicly available information.

5. The method of claim 1, further comprising, in response to no related process activity graph being identified, providing the unstructured data to the generative AI to generate a process activity graph in lieu of the related process activity graph.

6. The method of claim 1, wherein the potential improvement is derived from a domain expertise, a business simulation, or automatically by using the formula.

7. The method of claim 6, wherein the formula and the KPI information are derived from the domain expertise and are stored in a database.

8. The method of claim 6, wherein the formula is argmax_{i,,k}(V) and V corresponds to the value.

9. The method of claim 1, wherein the potential improvement serves as an input to a value computation that, for each potential KPI improvement, computes the value.

10. The method of claim 1, further comprising, causing the generative AI to use the related process to recommend or generate, based on the customer attributes and the customer pain point, the process activity graph.

11. The method of claim 1, further comprising, in response to the value being computed, using the formula to identify at least one of a pain point or a process activity.

12. The method of claim 1, further comprising verifying the process activity graph by domain experts to ensure accuracy and saving the verified process activity graph in the process activity vector DB.

13. The method of claim 1, further comprising saving the raw data in a process activity graph DB.

14. The method of claim 1, wherein the unstructured data sources comprise at least one of a customer discussion, meeting notes, or a recorded meeting.

15. The method of claim 1, wherein the customer attributes include a name, an industry, an organization type, and a revenue amount.

16. The method of claim 1, wherein the node represents an entity comprising a machine or a material.

17. The method of claim 1, further comprising saving a newly identified KPI or process activity in a future use of the customer process vector DB.

18. The method of claim 1, further comprising updating the customer KB with pre- and post-transformation KPIs for future comparative analysis.

19. The method of claim 1, further comprising encoding and storing, for the related process, a process name in at least one of the customer process vector DB or the customer process KB.

20. A non-transitory computer-readable medium for storing instructions for executing a process, the instructions comprising:
providing unstructured data associated with customer information, which is obtained from unstructured data sources comprising at least one of user-entered data, a customer portal, or an external source, as an input to a generative artificial intelligence (AI) to obtain customer attributes;
creating a customer profile and storing it, along with embeddings of the customer attributes, in a customer knowledge base (KB), wherein the generative AI uses a large language model to obtain from the unstructured data a customer pain point that is stored as raw data in the customer process KB and as embedded pain point in a customer process vector database (DB);
using the embedded pain point and the customer attribute to perform a lookup or a similarity search in the customer process vector DB to identify and obtain a related process activity graph associated with existing customer data and at least one of a related standardized customer pain point or a related process;
identifying an activity associated with a node or an edge of the related process activity graph that increases a likelihood of maximizing a value;
for at least some of the nodes and/or edges, iteratively performing steps comprising:
in response to identifying a key performance indicator (KPI) associated with the activity, computing the KPI by using at least one of the similarity search or a domain expertise and at least one of a formula or KPI information, which is obtained by using a similarity search on the customer KB, to identify a potential improvement in the KPI based on a comparative analysis of the computed KPIs with similar KPIs associated with similar organizations; and
selecting and outputting at least one of the customer pain point, process, or a process activity, which based on the computed KPI that has the highest likelihood of maximizing the value.
